(19) United States
(12) Patent Application Publication
(10) Pub. No.: US 2008/0061523 A1
(43) Pub. Date: Mar. 13, 2008

(54) Removable wheel system for footlockers

(76) Inventor: Ed Holand, Boyd, WI (US)

Correspondence Address: L. DAVID FERRARI, 29 STORY ST. #1, S. BOSTON, MA, 02127, US

(21) Appl. No.: 11/518,798

(22) Filed: Sep. 11, 2006

(51) Int. Cl. B62B 1/00

(52) U.S. Cl. 280/47.24

(57) ABSTRACT

A system of removable wheels for use with traveling cases. The invention discloses a removable wheel system for footlockers where the wheels are quickly and easily attachable and removable using a ball bearing/spring mechanism that does not require the use of tools.

### FIELD OF THE INVENTION

The present invention is directed toward traveling bags or cases, the wheels and other parts being enclosed therein. More specifically, the invention discloses a removable wheel system for footlockers where the wheels are quickly and easily attachable and removable using a ball bearing/spring mechanism that does not require the use of tools.

### BACKGROUND OF THE INVENTION

Damaged wheels are a common and growing problem with traveling cases. To alleviate this concern, there are many patents that disclose traveling bags with removable wheel systems. Currently, these products lack the capability for the wheels, upon which the axles are affixed, to be easily and quickly attached and removed without the use of tools.

There have been a number of disclosures in the prior art directed to the field of traveling bags where the supporting shaft or member on the wheels revolve is affixed to the traveling case itself. One such invention is U.S. Patent Application No. 20050017467 which discloses removable large wheels for a luggage case, having two permanent sleeves inserted in holes drilled in the pre-existing small wheel mounting blocks which contain the pre-existing small wheels. Two axles, one in each of the sleeves, with a permanent stop at the inner end of each axle and a spring loaded button at the outer end of each axle. Unlike the current invention, this invention features a system where the axles are attached to the case. Previous versions of this design include U.S Patent Application No. 2003141684 and U.S. Pat. Nos. 6,877,752 and 6,253,892.

Other inventions in the prior art feature traveling cases wherein the wheels attached are not removable. For example, U.S. Pat. No. 5,984,154 discloses a wheel away backpack where a pair of wheels mounted for rotation at the ends of a bottom rear edge of the bottom chassis.

Furthermore, there are a number of prior art disclosures wherein the traveling cases contain detachable wheels but require the use of tools for removal. For instance, U.S. Pat. No. 6,253,891 discloses a wheel unit for an article of luggage equipped with wheels to facilitate translation of the luggage along the ground. The wheel unit includes a wheel housing connected to the luggage and a wheel support and a wheel rotatably but removably connected to the wheel housing, the wheel support being mounted to the wheel housing in such a way that it is easily removable. The wheel may be quickly and easily replaced when damaged without disassembly of any other part of the luggage article. U.S. Pat. No. 6,113,196 discloses a detachable luggage wheel comprising a pedestal and a wheel located on a lower part of the pedestal, a recessed portion provided on a side of the pedestal adjacent to a hub of the wheel, and a blocking member complementary in a shape to the recessed portion for being able to cling to a resilient locking member of the recessed portion for providing the fit setting of the blocking member onto the recessed portion, and preventing a bolt of the wheel from loosening. U.S. Pat. No. 3,989,128 discloses a wheeled suitcase where the ground wheels of a wheeled suitcase are provided with a mount and a socket that is fixed to the suitcase to permit the wheels to be readily secured and removed. U.S. Pat. No. 6,279,926 discloses a removable wheel system for luggage, baggage, portfolios, art tubes, knapsacks, golf bags, briefcases, and back packs. A frame structure with an integrated wheel base engages the article, and straps with attaching means secure the frame structure to the article. In one embodiment, the frame structure has contacting lips upon which the luggage rests, while straps that are partly affixed to the luggage are threaded through securing slots of the frame structure and tightly secured. Cylindrical articles are carried by a frame structure with a Y shaped housing that secures the luggage to the frame by wrapping a strap around the luggage and engaging a securing slot on the frame.

U.S. Pat. No. 7,036,641 discloses a bag carrying system having a removable handle and wheel assembly is provided. The system includes a bag having a back portion with a panel overlying the back portion and a handle and wheel assembly comprising a handle portion, a wheel portion and a longitudinally extending supporting element connected there between. Significantly, the longitudinally extending supporting unit of the handle and wheel assembly is designed to be placed between the panel and back portion of the bag for releasably attaching the assembly thereto.

U.S. Pat. No. 6,659,477 discloses a semi rigid golf bag having a hollow cylindrical main section and a plurality of storage compartments for golf equipment. The main section is formed from two semicircular half sections having semi-rigid walls attached by hinges to allow a user to open the main section to access the storage compartments. There are two insertion slots formed in the cylindrical main section, an insertion slot capable of retaining a cylindrical insertion bar when the insertion bar is inserted into the insertion slot; two wheel assemblies, each wheel assembly having a wheel attached to metal tube, the tube having an open end capable of receiving the insertion bar; and an outside circle and an inside circle defined concentrically on said top end of cylindrical main section. U.S. Patent Application No. 20020003375 discloses a detachable wheel assembly of luggage comprising a bracket, a wheel unit mounted to bottom of the bracket, and a screw wherein the claw of the wheel unit is snapped into the slot of the bracket and the screw is driven through the wheel unit to the bracket in the rear to secure them together. By utilizing this, the detachment of wheel is achieved by simply unscrewing the screw from the wheel assembly, thus facilitating the replacement of wheel.

Many disclosures in the prior art do contain easily detachable wheels or wheel assemblies. However, none of these disclose the ball bearing/spring mechanism that the present invention features. For example, U.S. Pat. No. 5,396,974 discloses a luggage case with easily removable wheels and feet. These external fittings attach to the outside of the luggage shell and have a projection which extends to an aperture in the wall of the case shell to the inside of the case. A manually releasable latch, such as a clip, engages and disengages this projection from the inside of the case to mount the wheel and the leg to the outside of the case. This attaching system also acts as an anchoring device for the straps normally used to hold and arrange clothing when packed inside the assembled case. This external fitment system is especially useful when the two shells of the case are stored one within the other during shipping by the manufacturer and storage by the consumer. U.S. Pat. No. 4,094,391 discloses a suitcase with wheels and transporting hook where a long, bent hook and a set of detachable wheels are used to transport luggage. The housing for the wheels is attached to a suitcase by means of a self-adhesive plate. The wheel axles are spring loaded so they can be removed. The hook incorporates a metal rod bent 270 degrees at one end to form a handle and a perpendicularly bent J-shaped hook at the other end that is used for holding one or more bags. Furthermore, the metal rod is again bent about a third of the way from the handle to the hook.

U.S. Pat. No. 4,900,043 discloses a system of wheel holding brackets that are attached to suitcases where an axle wheel assembly is removably attached to the base of a suitcase by attaching a pair of brackets to opposite sides of the base of the suitcase. The upper edge of each bracket is provided with a downwardly extending slot. A pivotally mounted slot entrance cover is mounted on the bracket and is pivotal in one direction to cover the entrance to the slot to prevent the axle of the axle wheel assembly from falling out of the slot once the axle is inserted in the slot, and pivotal in another direction to open the entrance to the slot to permit the removal of the axle from the slot.

U.S. Pat. No. 3,997,038 discloses a wheeled suitcase where the ground wheels of a wheeled suitcase are provided with axles, and mounting means are formed on the suitcase to permit the axles to be readily secured and removed.

U.S. Pat. No. 3,861,703 discloses a luggage carrier where caster wheels which are attachable to and detachable from containers such as items of luggage by means of bonded Velcro strips. The Velcro strips are formed so as to attach to each other, with one Velcro strip having a surface of hooked projections which latch onto the mating surface of projecting loops of the other Velcro strip. One Velcro strip is fastened to the bottom of the luggage container by means of adhesive or other fastening means, and the mating Velcro strip is fastened to one or more caster wheel mountings.

U.S. Pat. No. 5,188,381 discloses a wheel holding bracket assembly for suitcases for detachably attaching large wheels to the bottom of a suitcase. The wheels are connected together by a common axle. A bracket is molded or attached to the bottom of the suitcase and the bracket has axle receiving slots formed therein. A lever is pivotally mounted on the bracket, and when the axle of the wheels is inserted in the axle receiving slots, the lever is pivoted in a direction which closes off the entrance to the slot and locks the axis in the slot. A device is provided for pivoting the lever in a direction which allows the axle to be removed from the slot.

U.S. Pat. No. 6,116,701 discloses a detachable luggage wheel structure. The detachable luggage wheel structure comprises a pedestal, a wheel assembly located on a lower part of the pedestal, a fixed member provided on the pedestal, a bolt, and a block secured to the fixed member from the below by the bolt for preventing the wheel axis from unfastening. Moreover, the wheel detachment is complete simply by unfastening the bolt from the exterior of the luggage and extracting the wheel thereof.

U.S. Pat. No. 5,280,767 discloses stackable rectangular containers, such as those for receiving pets, the top and bottom half of each container having spaced ledges adjacent the corners of the container for receiving extensions of the bases of rollers, when needed. When the rollers are removed, the containers become securely stacked by having upstanding rectangular portions which interfit with those of a stacked container at the four corners.

Consequently, there is a need for a traveling case with a wheel system where the wheels are easily attached and removed without the need for any external tools. Accordingly, the present invention described herein encompasses these elements to create a removable wheel system for footlockers.

### BRIEF SUMMARY OF THE INVENTION

It is an object of the present invention is to provide a removable wheel system for footlockers.

It is a further object of the invention to provide a system where the wheels can be easily attached and detached using a ball bearing/spring mechanism that does not require the use of any tools.

It is a further object of the invention to provide a system where the wheels are locked into place by inserting the ball bearing/spring mechanism into a cylindrical tube that is affixed to the base of the footlocker. The wheels can then be removed easily by depressing the spring mechanism.

It is a further object of the invention to provide a system where the supporting shaft or member on which the wheel revolves is permanently fixed to the wheels and is removable along with the wheels, so as to avoid damage as the footlockers is transported.

In accordance with another aspect of the invention, the removable wheel system described above can be affixed to a handcart which is used to carry traveling cases.

### BRIEF DESCRIPTION OF SEVERAL VIEWS OF THE DRAWING

The accompanying drawings, which are incorporated herein and constitute a part of the specification, illustrate presently preferred embodiments of the invention. Together with the general description given above and the detailed description of the preferred embodiments given below, they serve to explain the principles of the invention.

FIG. 1 illustrates a perspective view of the removable wheel system attached to a footlocker.

FIG. 2 is an exploded view of the footlocker in FIG. 1 showing the cylindrical tube wherein the removable wheel system is inserted.

FIG. 3 is a diagram illustrating a removable wheel with a ball bearing/spring mechanism located on the wheel's axle.

FIG. 4 is a diagram illustrating the footlocker shown in FIG. 1 wherein the removable wheels are inserted into the cylindrical tube.

FIG. 5 is a diagram illustrating an alternative embodiment of the invention where the removable wheel system is attached to a handcart that can be used to transport traveling cases.

### DETAILED DESCRIPTION OF THE INVENTION

It will be readily understood that the components of the present invention, as generally described herein, could be arranged and designed in a wide variety of different formulations. Thus, the following more detailed description of the compositions or formulations of the present invention are not intended to limit the scope of the invention as claimed, but are merely representative of the presently preferred embodiments of the invention.

Reference will now be made in detail to the presently preferred embodiment of the invention, examples of which are illustrated in the accompanying drawings, wherein like reference numerals refer to like elements throughout.

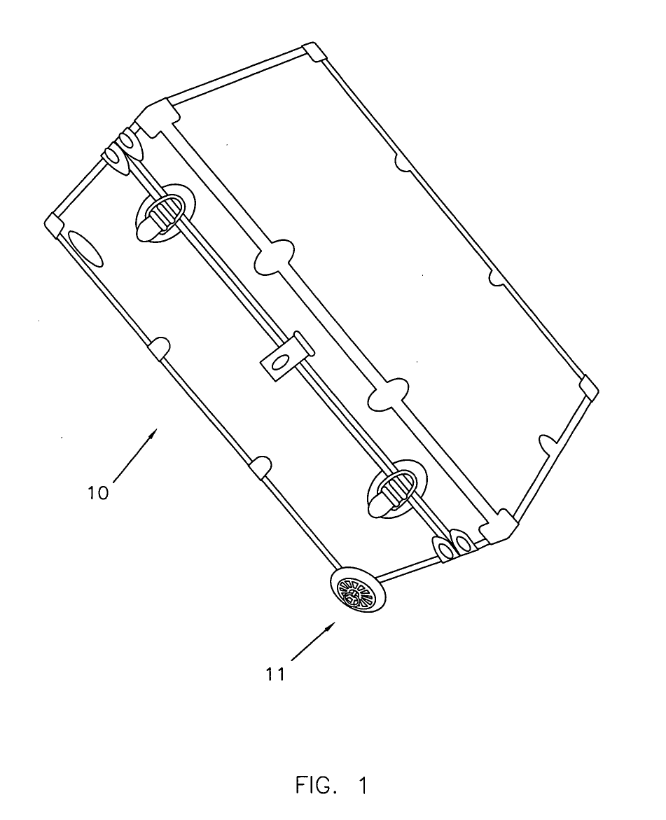

FIG. 1 shows a footlocker 10 with the removable wheel system 11 inserted. With the wheels attached, the footlocker can be easily pulled. The wheels can then be removed to avoid damage as the footlocker is in transport.

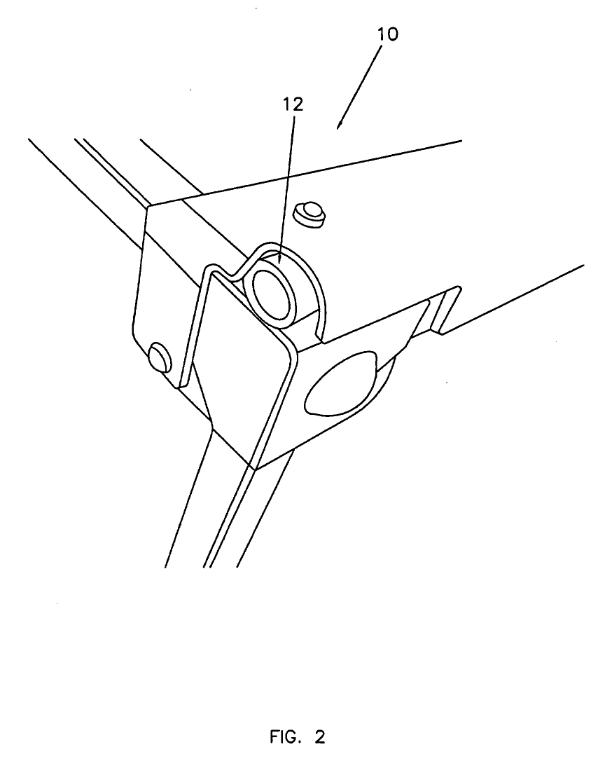

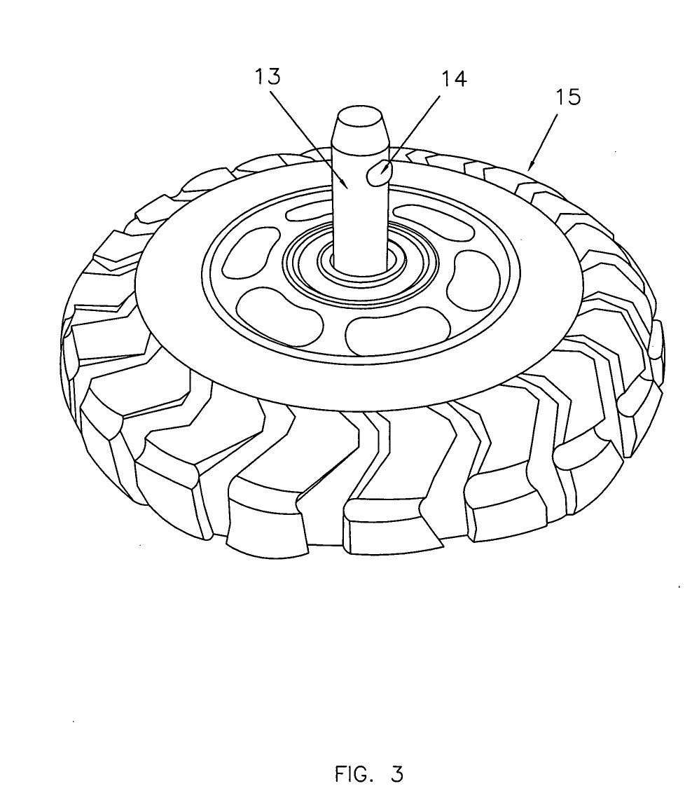

FIG. 2 shows a cylindrical tube 12 that is fitted on the bottom of the footlocker. The removable wheel system 11 shown in FIG. 3 is easily inserted into the tube. The wheel 15 and attached wheel axle 13 are inserted in the cylindrical tube and locked into place using the pressure created by the spring loaded ball bearing mechanism 14.

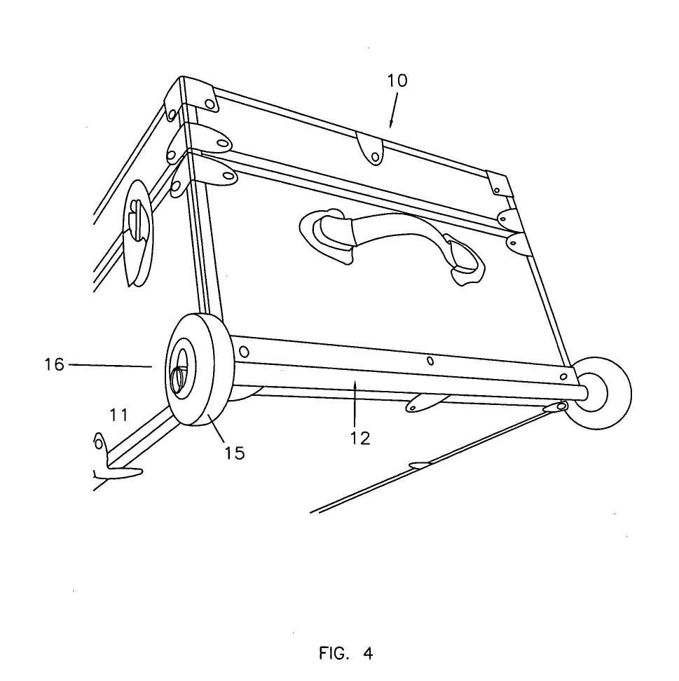

As seen in FIGS. 3 and 4, when the footlocker is to be loaded for transport, the wheel system can be quickly and easily removed without the use of any tooling when the spring loaded ball bearing mechanism 14 is depressed and the wheel 15 along with the attached axle 13 can be removed using a ring shaped lever 16 found on the outer end of the wheel axle.

The invention is not limited to wheels of any particular diameter or material, although wheels that are capable of transporting a standard size footlocker are preferred. The wheels can be constructed of metal with a rubber tread portion, a suitable plastic material or other standard materials of construction used for wheels in the field of traveling cases.

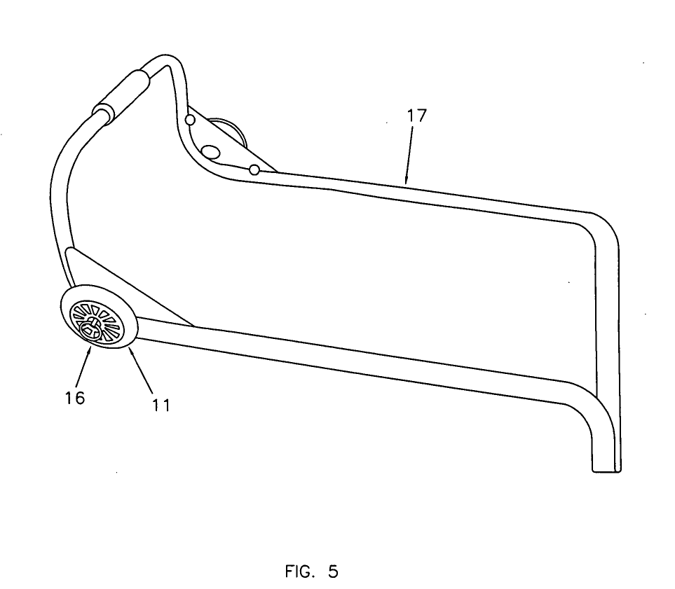

FIG. 5 shows another embodiment of the invention where a handcart 17 can be used to hold a footlocker or other style of traveling case. The removable wheel system 11 is attached to and removed from the handcart in the same manner as described above.

It is appreciated that additional advantages, modifications and equivalent embodiments will be apparent to those skilled in the art. Therefore, the invention in its broader aspects is not limited to the specific details and representative devices as shown and described herein. Accordingly, various modifications may be made without departing from the true spirit or scope of this invention as defined by the appended claims and their equivalents.

I claim:

1. A system of removable wheels capable for use with traveling cases comprising:
a spring loaded ball bearing mechanism;
a removable wheel; and
a supporting axle on which the wheel revolves,
said system of removable wheels capable of being easily attached and detached.

2. A system of removable wheels as set forth in claim 1, wherein the axle is directly attached to the wheel and is removed along with wheel.

3. A system of removable wheels as set forth in claim 1, wherein the spring loaded ball bearing mechanism is located on the wheel axle.

4. A system of removable wheels as set forth in claim 1, wherein a ring shaped lever is located on the outer end of the wheel axle can be used to remove the wheel system.

5. A traveling case with a cylindrical tube that is fitted on the bottom of said case wherein the removable wheel system set forth in claim 1 can be inserted.

6. A system of removable wheels as set forth in claim 1, wherein the wheel is secured in the cylindrical tube as further set forth in claim 5 by the pressure exerted by the spring loaded ball bearing mechanism.

7. A system of removable wheels as set forth in claim 1, wherein the wheels can be easily removed without the use of tools by depressing the spring loaded ball bearing mechanism to remove the wheel.

8. A handcart fitted comprising:
slots wherein the system of removable wheels as set forth in claim 1 can be inserted; and
capable of transporting a traveling case for convenient transportation.
